(19) United States
(12) Patent Application Publication
(10) Pub. No.: US 2004/0080538 A1
(43) Pub. Date: Apr. 29, 2004

(54) Systems and methods for providing information to a user via a mobile appliance

(76) Inventor: Roger Jollis, Fort Collins, CO (US)

Correspondence Address: HEWLETT-PACKARD COMPANY, Intellectual Property Administration, P.O. Box 272400, Fort Collins ., CO, 80527-2400, US

(21) Appl. No.: 10/281,491

(22) Filed: Oct. 28, 2002

(51) Int. Cl. G09G 5/00

(52) U.S. Cl. 345/772

(57) ABSTRACT

Methods for providing information to users via mobile appliances are provided. One such method includes: using an executing application to generate a display field on a mobile appliance; receiving information at the mobile appliance; and displaying an indicium to the user within the mobile appliance, the indicium being configured to inform the user of a category of content associated with the information received, the indicia lacking at least a portion of the content associated with the information received. Systems and computer-readable media also are provided.

### BACKGROUND

When a user accesses information via a communications network, such as the Internet, information is often passed to the user in the form of alerts and advertisements, for example. This information typically is provided by intersticials, e.g., pop-up windows, that are presented within respective windows of browser applications. Unfortunately, intersticials normally are not sensitive to the screen size of a display device. This typically is not a problem when the user is operating a personal computer that includes a display device of sufficient size for displaying such an intersticial.

Mobile appliances, such as handheld wireless devices, however, tend to suffer from display area, memory and communication bandwidth limitations. Of particular concern is that these limitations can render the use of conventional intersticials incompatible with many mobile appliances. In particular, if a mobile appliance attempts to display an intersticial, the display screen, memory and/or communication bandwidth resources of the mobile appliance could be overloaded, thus limiting the ability of the appliance to execute onboard applications, for example. Because of this, some mobile appliances disable the ability of intersticials to be provided by Web sites, for example.

### SUMMARY

In representative embodiments, systems and methods disclosed herein provide information to users via mobile appliances. In this regard, an embodiment of a method includes: using an executing application to generate a display field on a mobile appliance; receiving information at the mobile appliance; and displaying an indicium, at least partially, within the display field of the executing application, the indicium being configured to inform the user of a category of content associated with the information received, the indicium lacking at least a portion of the content associated with the information received.

In another representative embodiment, a method is provided which includes: providing information to a user via a mobile appliance, the information including an indication of content such that the mobile appliance is enabled to display an indicium, the indicium being configured to inform the user of a category of the content associated with the information received, the indicium lacking at least a portion of the content associated with the information received.

In another representative embodiment, a system is provided which includes a mobile appliance having an information alert system that is operative to receive information provided to the mobile appliance. The information alert system also is operative to display an indicium. Specifically, the indicium is configured to inform the user of a category of content associated with the information received, with the indicium lacking at least a portion of the content associated with the information received.

In still another representative embodiment, a system is provided which includes means for executing an application to generate a display field on a mobile appliance, and means for receiving information at the mobile appliance. The system also includes means for displaying an indicium, at least partially, within the display field of the application such that the indicium informs the user of a category of content associated with the information received. Note, the indicium lacks at least a portion of the content associated with the information received.

In yet another representative embodiment, a computer-readable medium is provided which includes logic configured to receive a preformatted text stream provided to a mobile appliance, and logic configured to display an indicium via the mobile appliance. The indicium is configured to inform the user of a category of content associated with the preformatted text stream with the indicium lacking at least a portion of the content associated with the preformatted text stream.

Other systems, methods, features, and/or advantages will be or may become apparent to one with skill in the art upon examination of the following drawings and detailed description. It is intended that all such additional systems, methods, features, and advantages be included within this description, and be protected by the accompanying claims.

### DESCRIPTION OF THE DRAWINGS

The embodiments of the systems and methods disclosed here can be better understood with reference to the following drawings. The components in the drawings are not necessarily to scale, emphasis instead being placed upon clearly illustrating the principles. Moreover, in the drawings, like reference numerals designate corresponding parts throughout the several views.

FIG. 1 is a schematic diagram depicting an embodiment of a communication system.

FIG. 2 is a flowchart depicting functionality of the communication system of FIG. 1.

FIG. 3 is a schematic diagram depicting a computer or processor-based device that can be utilized to implement an embodiment of an information alert system.

FIG. 4 is a flowchart depicting functionality of an embodiment of an information alert system.

FIG. 5 is a schematic diagram depicting a representative mobile appliance and associated display screen with an embodiment of an alert indicia being displayed within a display field of an executing application.

FIG. 6 is a schematic diagram depicting multiple examples of indicia that can be used by an embodiment of an information alert system.

FIG. 7 is a flowchart depicting functionality of another embodiment of an information alert system.

FIG. 8 is a flowchart depicting functionality of another embodiment of an information alert system.

FIG. 9 is a schematic diagram depicting a representative mobile appliance showing actuation of a menu in response to actuating the displayed indicia.

FIG. 10 is a schematic diagram of the mobile appliance of FIG. 9 showing content being provided to the user when the indicia has been actuated.

### DETAILED DESCRIPTION

As will be described in greater detail here, systems and methods enable information to be provided to users via mobile appliances. In particular, embodiments can be used to provide users with an indication that an application of the mobile appliance has experienced a change of status. As used here, a change of status refers to the occurrence of an event associated with an application. By way of example, an email application exhibits a change of status when an email message is received. As another example, a scheduling application exhibits a change of status when an appointment alarm is to be activated.

Typically, in response to the change of status, indicia is displayed to the user, with the indicia being configured to inform the user about the change of status, e.g., the type of information received by the mobile appliance. Based on the type of information received, the user may decide to view the underlying contents of the information or may delete the information, for example.

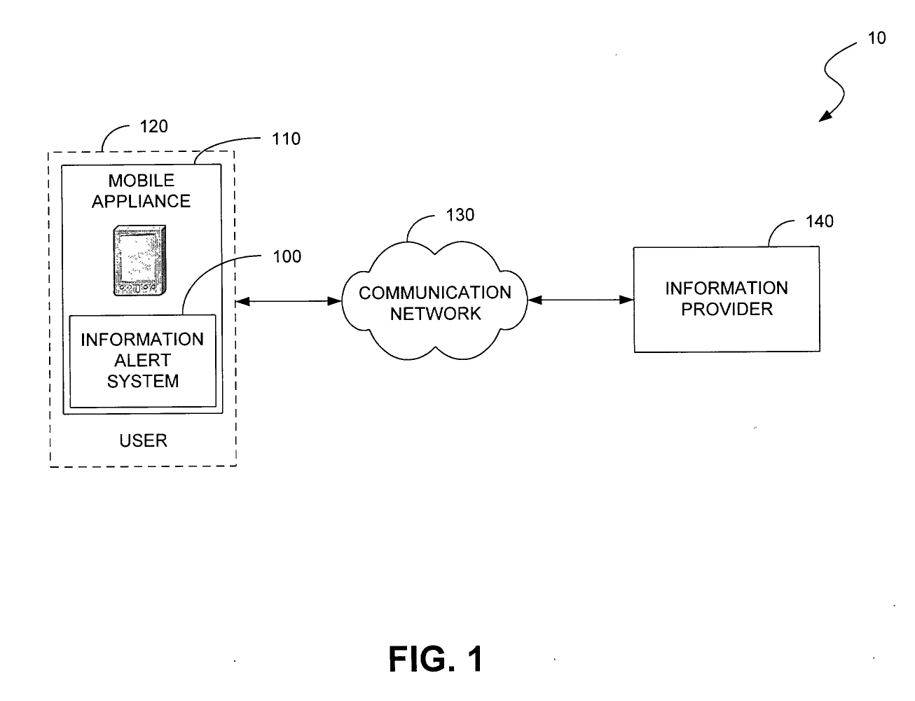

Referring now to the drawings, FIG. 1 is a schematic diagram depicting an embodiment of a communication system 10. As shown in FIG. 1, communication system 10 includes an information alert system 100. The information alert system 100 is associated with a mobile appliance 110, which enables user 120 to communicate with a communication network 130. As used herein, a mobile appliance is any portable device capable of transmitting and/or receiving data, such as a personal digital assistant (PDA), laptop computer or phone. Note, communication network 130 may be any type of communication network employing any network topology, transmission medium, or network protocol. For example, such a network may be any public or private packet-switched or other data network, including the Internet, circuit-switched networks, such as the public switched telephone network (PSTN), wireless network, or any other desired communications infrastructure and/or combination of infrastructures.

By using the mobile appliance 110, user 120 can receive information from and/or provide information to information provider 140, which also communicates with communication network 130. By way of example, information provider 140 can operate a Web site from which the user can obtain information.

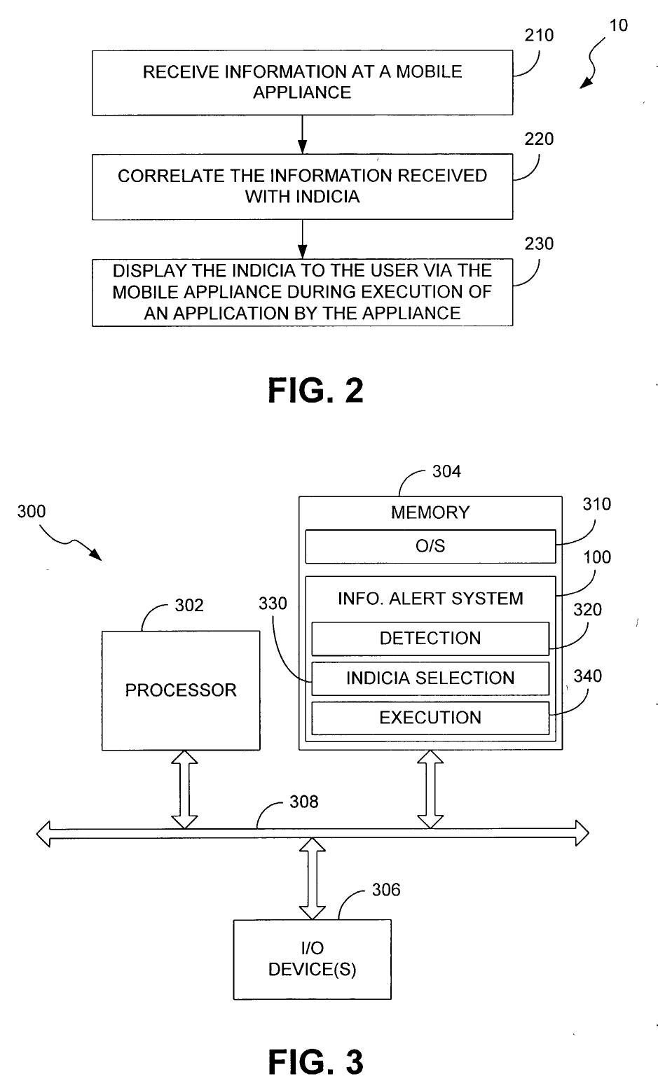

Functionality of communication system 10 of FIG. 1 is shown in the flowchart of FIG. 2. As shown in FIG. 2, the functionality may be construed as beginning at block 210, where information is received at a mobile appliance. In block 220, the information received is correlated with an indicium. In particular, a registry of multiple indicia is stored by the mobile communications device, as will be described later. The information received then is compared with the registry of indicia and a particular indicium is selected based upon the type of information received. In block 230, the indicium is displayed to the user via the mobile communications device. Typically, the indicium is displayed at least partially within a display field that is associated with an application currently being executed by the mobile appliance.

Information alert systems 100 can be implemented in software, firmware, hardware, or a combination thereof. When implemented in hardware, information alert system 100 can be implemented with any or a combination of various technologies. By way of example, the following technologies, which are each well known in the art, can be used: a discrete logic circuit(s) having logic gates for implementing logic functions upon data signals, an application specific integrated circuit(s) (ASIC) having appropriate combinational logic gates, a programmable gate array(s) (PGA), and a field programmable gate array(s) (FPGA).

When implemented in software, information alert system 100 can be a program that is executable by a digital computer, e.g., a digital computer contained in or configured as a mobile appliance, an example of which is depicted schematically in FIG. 3. In FIG. 3, computer 300 includes a processor 302, memory 304, and one or more input and/or output (I/O) devices 306 (or peripherals) that are communicatively coupled via a local interface 308. Processor 302 can be a hardware device configured to execute software that can be stored in memory 304. Memory 304 can include any combination of volatile memory elements and/or nonvolatile memory elements. Moreover, memory 304 can incorporate electronic, magnetic, optical, and/or other types of storage media. Note that memory 304 can have a distributed architecture, where various components are situated remote from one another, but can be accessed by processor 302.

The software in memory 304 can include one or more separate programs, each of which comprises an ordered listing of executable instructions for implementing logical functions. The software in the memory 304 includes information alert system 100 and a suitable operating system (O/S) 310. The operating system 310 controls the execution of other computer programs, such as information alert system 100, which includes change-of-status detection system 320, indicia selection system 330 and execution system 340. Each of the systems 320, 330 and 340 will be described in detail later.

The I/O device(s) 306 can include input devices such as a keypad and/or stylus. I/0 device(s) 306 also can include output devices such as a display device and/or speaker, for example. I/0 device(s) 306 may further include devices that are configured to communicate both inputs and outputs such as a communication interface and/or antenna, for example.

When information alert system 100 is implemented in software, it should be noted that the information alert system 100 can be stored on any computer-readable medium for use by or in connection with any computer-related system or method. In the context of this document, a computer-readable medium is an electronic, magnetic, optical, or other physical device or means that can contain or store a computer program for use by or in connection with a computer-related system or method. Information alert system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

As used herein, a “computer-readable medium” can be any means that can store, communicate, propagate or transport a program for use by or in connection with an instruction execution system, apparatus, or device. Thus, a computer readable medium can be, for example but not limited to, an electronic, magnetic, optical, electromagnetic, infrared, or semiconductor system, apparatus, device, or propagation medium. More specific examples (a nonexhaustive list) of a computer-readable medium include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program could be electronically captured, via optical scanning of the paper or other medium, then compiled, interpreted or otherwise processed in a suitable manner, if necessary, and then stored in a computer memory.

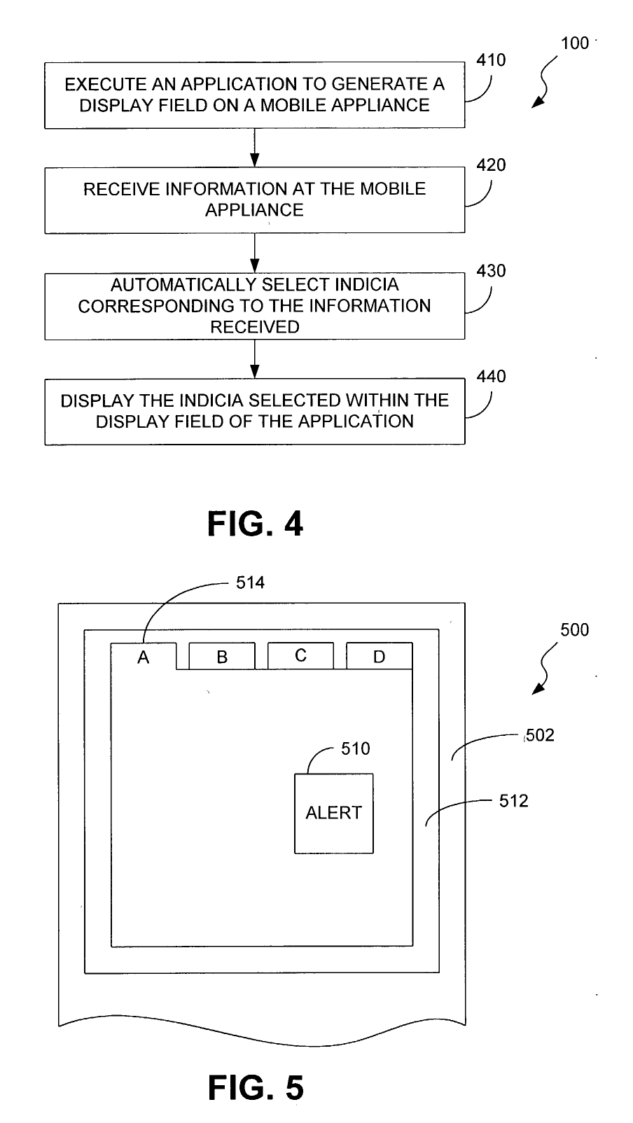

Reference will now be made to the flowchart of FIG. 4, which depicts the functionality of an embodiment of information alert system 100. In this regard, each block of the flowchart represents a module segment or portion of code that comprises one or more executable instructions for implementing the specified logical function(s). It should also be noted that in some alternative implementations, the functions noted in various blocks of FIG. 4, or any other of the accompanying flowcharts, may occur out of the order in which they are depicted. For example, two blocks shown in succession in FIG. 4 may, in fact, be executed substantially concurrently. In other embodiments, the blocks may sometimes be executed in the reverse order depending upon the functionality involved. In still other embodiments, one or more of the blocks may be omitted.

As shown in FIG. 4, the functionality (or method) of an embodiment of an information alert system 100 may be construed as beginning at block 410, where an application is executed to generate a display field on a mobile appliance. In block 420, information is received at the mobile appliance. For example, the information corresponds to an alert that is intended to be displayed to the user in the form of an intersticial. However, as mentioned before, various limitations of the mobile appliance may prevent generation of an intersticial. In block 430, an indicium corresponding to the information received is automatically selected. Thereafter, such as depicted in block 440, the indicium selected is displayed, at least partially, within the display field of the executing application.

As mentioned before, embodiments of the information alert system 100 can include various modules or subsystems, such as change-of-status detection system 320, indicia selection system 330 and/or execution system 340, which were depicted in FIG. 3. Specifically, change-of-status detection system 320 determines when information is to be graphically presented to a user via a display device of the mobile appliance. This can include determining whether a currently executing application has changed status and/or whether an application that is running in the background has changed status.

The indicia selection system 330 determines whether the detected change of status corresponds to one or more stored indicia. Upon selection of an appropriate indicium, that indicium can be displayed to the user.

Execution system 340 is used to determine whether and/or how the user actuates the displayed indicium. Based upon the type of actuation selected, the execution system 340 processes information associated with the change of status in a manner corresponding to the actuation type (described later).

An example of an indicium being displayed to the user during execution of an application is depicted schematically in FIG. 5. In FIG. 5, mobile appliance 500 is depicted as including a display screen 502 within which multiple application folders are displayed. Clearly, each of the application folders could be associated with a specific application. In this example, application “A” is currently executing. Note, application A is an address book.

Indicium 510 is displayed within the display field 512 of application A. Generally, the display field 512 corresponds to the outer periphery of the file folder 514. In this embodiment, the indicium 510 is located entirely within the display field 512. In other embodiments, the alert may only partially overlap the display field 512, or may not overlap the display field at all.

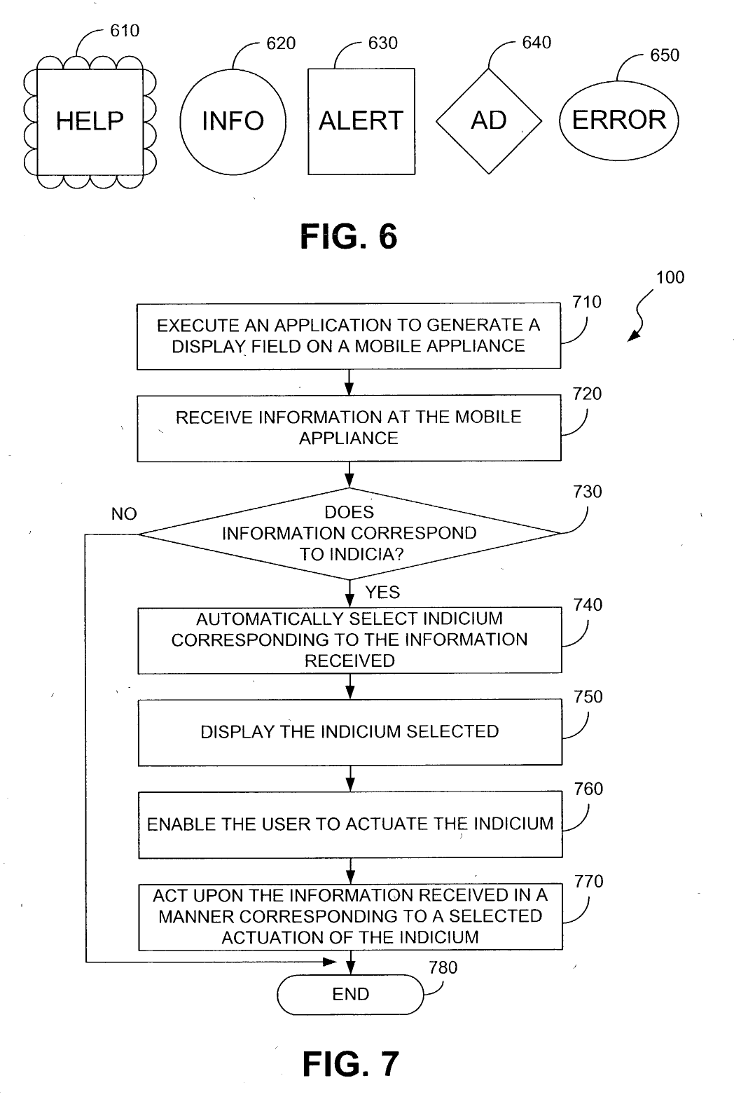

Multiple indicia typically are provided for use by an alert information system. By providing various indicia, a particular indicium can be associated with a particular type of information. FIG. 6 depicts several examples of indicia. As shown in FIG. 6, indicium 610 corresponds to help information and is generally shaped as a postage stamp. Indicium 620 corresponds to general information and is generally circular in shape. Indicium 630 corresponds to alert information and is generally configured as a square. Indicium 640 corresponds to an advertisement and is generally configured as a diamond. Indicium 650 corresponds to error information and is generally configured as an oval.

Indicia can be configured in various shapes, sizes and colors, and can include text identifiers that generally inform the user of the nature of the corresponding content or information. Preferably, each of the indicia incorporates a generally simplistic design that does not require a large amount of memory for storage.

As shown in FIG. 7, the functionality (or method) of another embodiment of an information alert system may be construed as beginning at block 710, where an application is executed to generate a display field on a mobile appliance. In block 720, information is received at the mobile appliance. Thereafter, if it is determined that the information received corresponds to at least one of the established indicia (block 730), an indicium is automatically selected that corresponds to the information received (block 740). If the information does not correspond to an established indicium, the process may end at block 780. In block 750, the indicium selected is displayed to the user. For example, the indicium can be displayed at least partially within the display field of the currently executing application. Thereafter, such as depicted in block 760, the user is enabled to actuate the indicium. In particular, the user is enabled to actuate the indicium so that at least a portion of the content corresponding to the received information is displayed to the user. As an alternative, the user may actuate the indicium in such a manner that the underlying content is stored by the mobile appliance, such as for later viewing. As another alternative, the underlying content may be deleted. Clearly, this can involve removing the displayed indicia from the display field. Thus, as depicted in block 770, the information received is acted upon in a manner corresponding to a selected actuation of the indicium. Note, this functionality can be attributed to an information execution system, such as system 340 depicted in FIG. 3.

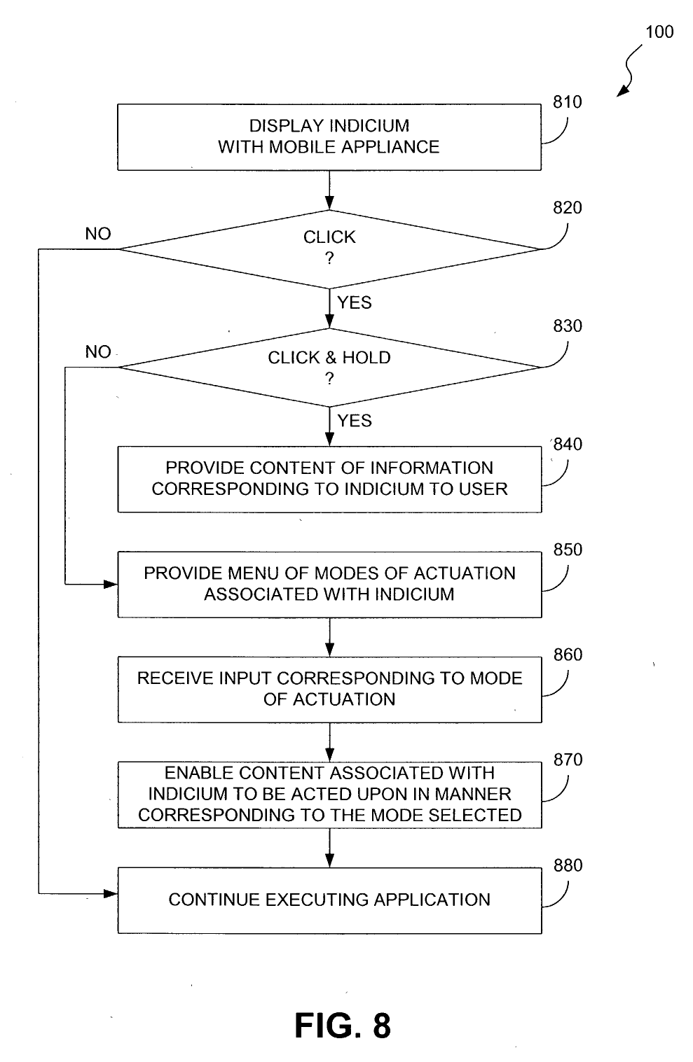

Functionality of another embodiment of an information alert system 100 is depicted in the flowchart of FIG. 8. As shown in FIG. 8, the functionality may be construed as beginning at block 810, where, in response to receiving information, an indicium is displayed to a user. For instance, the indicium can be displayed, at least partially, within a display field of an executing application on a mobile appliance. In block 820, a determination is made as to whether the indicium has been actuated, e.g., clicked. By way of example, the determination can include whether the indicium has been actuated with a stylus of the mobile appliance. If it is determined in block 820 that the indicium has been clicked, a further determination is made (block 830) as to whether the indicium also has been “held.” Otherwise, the process proceeds to block 880, the functionality of which will be described later. If it is determined that the indicium has been clicked and held (block 830), the process proceeds to block 840, where content corresponding to the indicium and, thus, the information received, is provided to the user. More specifically, the content can be displayed in addition to or in lieu of the currently executing application. If, however, it is determined in block 830 that the indicium has been clicked and not held, the process proceeds to block 850, where a menu of potential modes of actuation associated with the indicium is provided to the user. Then, in block 860, input corresponding to the mode of actuation selected by the user is received. In block 870, the content associated with the indicium is processed, e.g., displayed, saved, deleted, in a manner corresponding to the selected mode of actuation. In block 880, operation of the executing application is continued.

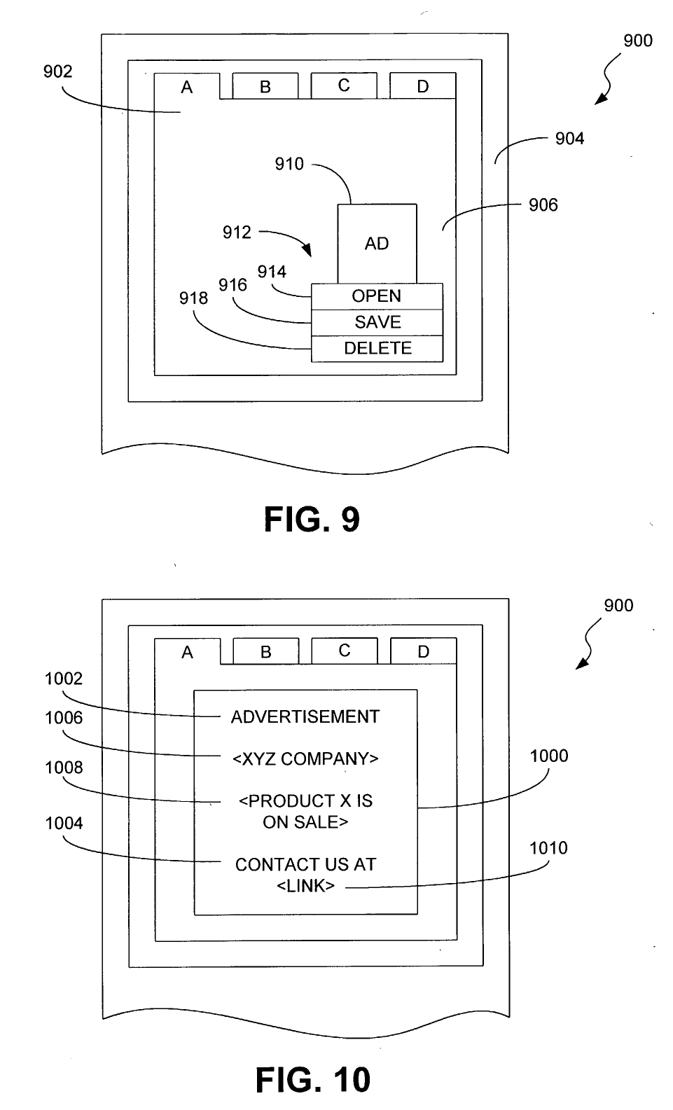

FIG. 9 schematically depicts a representative mobile appliance 900 in which an application 902 is currently executing. In particular, the display device 904 of the mobile appliance is providing a display field 906 associated with application A. Within the display field, an alert indicium 910 is displayed. In particular, the alert indicium has been actuated so that a menu 912 of modes of actuation is also currently displayed to the user. The modes of actuation of this indicium include “open” 914, “save” 916 and “delete” 918. Note, actuation of “save” 916 causes the content associated with the indicium to be saved in memory. Actuation of “save” 916 also initiates removal of the indicium 910 from the display device. In contrast, actuation of “delete” 918 causes the content to be deleted from memory and initiates removal of the indicium from the display device. Functionality of“open” 914 is depicted and described in greater detail later with respect to FIG. 10.

Various techniques can be used for actuating indicia. By way of example, a stylus can be used. When using such a stylus, clicking the indicium can provide the user with a menu that includes various options such as “read,” “save,” “help,” and “delete.” Additionally, or alternatively, the indicium can be clicked and held so that the underlying content of the indicium is displayed to the user. By clicking and holding outside the indicium, the underlying content corresponding to the indicium can be saved to a message queue. Further, by tracing an “x” on the indicium, the indicium as well as the underlying content can be deleted.

As shown in FIG. 10, actuation of “open” 914 causes content associated with the received information to be displayed to the user. Although shown as being displayed within the display field of the executing application, the content may entirely obscure any graphic information associated with an executing application in some embodiments. Note, the content window 1000 used to display the content includes various fields, with some of the fields optionally being fixed, e.g., field 1002, and others of the fields being suitable for modification, e.g., fields 1004, 1006 and 1008, by the,provider of the information. These fields can be filled by information carried by a signal that is configured with a pre-established message format. By way of example, the information can be in the form of a text stream. The information alert system receives the information and configures the text in a stylized format that may be user customizable. Thus, much like the users of some phones can select a desired ring tone, in some embodiments, a user can select a particular configuration in which text is to be displayed. The use of a pre-established message format may further enhance the ability of information alert systems to provide information to users without surpassing the bandwidth, processing and/or display capabilities of a mobile appliance. Thus, various message formats can be established and used so that fixed and/or modifiable fields can be developed to provide information to a user that has reduced device impact while providing an appropriate visual impact to the user.

In some embodiments, a pre-established message format can include a label or tag that indicates the type of information that is to be provided to the user of a mobile appliance. By way of example, the label could indicate whether the information corresponds to an advertisement or an error message. Once an information alert system determines the type of information, the preformatted data can be associated with an appropriate indicium that is to be displayed to the user. Correlating the preformatted data with the appropriate indicium also enables the alert information system to provide the user with information in a preformatted manner. Specifically, if it is determined that the preformatted data corresponds to an advertisement, the information alert system can determine which portions of the received data are to be used to fill the “company,” “product” and “link” fields depicted in the example embodiment of FIG. 10. Note, the preformatted data also can include data that enables various functionality associated with the indicium that is to be displayed to the user. By way of example, the preformatted data can prompt the alert system to provide a drop-down menu that includes selections such as “yes ” “no,” “confirm,” and “close,” for example. The data necessary to enable the underlying functionality if any of the selections are actuated also can be included in the preformatted information.

It should be emphasized that many variations and modifications may be made to the above-described embodiments. All such modifications and variations are intended to be included herein within the scope of this disclosure and protected by the following claims.

1. A method for providing information to a user via a mobile appliance, said method comprising:
using an executing application to generate a display field on a mobile appliance;
receiving information at the mobile appliance; and
displaying an indicium to the user with the mobile appliance, the indicium being configured to inform the user of a category of content associated with the information received, the indicium lacking at least a portion of the content associated with the information received.

2. The method of claim 1, further comprising:
enabling the user to actuate the indicium; and
displaying at least a portion of the content associated with the information received in response to actuation.

3. The method of claim 1, wherein displaying the indicium is enabled despite the mobile device being unable to display an intersticial.

4. The method of claim 1, wherein in displaying the indicium, the indicium is displayed at least partially within the display field of the executing application.

5. The method of claim 1, further comprising:
automatically selecting the indicium from among a group of indicia stored by the mobile appliance, each of the indicia being associated with a category of content.

6. The method of claim 1, further comprising:
enabling the user to actuate the indicium selectively; and
processing the information received in a manner corresponding to a selected actuation of the indicia.

7. The method of claim 6, wherein enabling the user to actuate the indicium selectively comprises enabling the user to actuate the indicium selectively in at least one of:
a first mode such that the content of the information received is displayed to the user;
a second mode such that the content of the information received is stored in memory of the mobile appliance and the indicium is removed from the display field; and
a third mode such that the content of the information received is deleted from the mobile appliance and the indicium is removed from the display field.

8. The method of claim 1, wherein, in enabling an indicium to be displayed, the indicium visually indicates the category of content associated with the information received, the category being selected from: an alert message, an advertisement, a help message, an information message and an error message.

9. The method of claim 1, further comprising:
determining whether another application associated with the mobile appliance has changed state; and
if the state has changed, displaying an indicium to the user to inform the user of the change of state.

10. A method for providing information to a user, said method comprising:
providing information to a user via a mobile appliance, the information including an indication of content such that the mobile appliance is enabled to display an indicium, the indicium being configured to inform the user of a category of the content associated with the information received, the indicium lacking at least a portion of the content associated with the information received.

11. The method of claim 10, wherein the mobile appliance is enabled to display the indicium despite being unable to display an intersticial.

12. The method of claim 10, wherein, in providing the information, the content is identified by a category selected from: an alert message, an advertisement, a help message, and an error message.

13. The method of claim 12, wherein in providing the information, the information is preformatted as a text stream.

14. A system for providing information to a user, said system comprising:
a mobile appliance having an information alert system operative to receive information provided to a mobile appliance and display an indicium, the indicium being configured to inform the user of a category of content associated with the information received, the indicium lacking at least a portion of the content associated with the information received.

15. The system of claim 14, wherein the information alert system is operative to enable the user to actuate the indicium and display at least a portion of the content associated with the information received upon actuation.

16. The system of claim 14, wherein the information alert system is operative to select the indicium automatically from among a group of indicia stored by the mobile appliance, each of the indicia being associated with a category of content.

17. The system of claim 14, wherein the information alert system is operative to enable the user to actuate the indicium selectively in at least one of:
a first mode such that the content of the information received is displayed to the user;
a second mode such that the content of the information received is stored in memory of the mobile appliance and the indicium is removed from the display field; and
a third mode such that the content of the information received is deleted from the mobile appliance and the indicium is removed from the display field.

18. The system of claim 14, wherein the information alert system is operative to store a group of indicia, each of the indicia corresponding to a category of content associated with the information received, the category being selected from: an alert message, an advertisement, a help message, and an error message.

19. The system of claim 14, wherein the mobile appliance is unable to display content of an intersticial received at the mobile appliance.

20. The system of claim 14, wherein the information is a text stream; and
wherein the information alert system populates text fields with the information for display to the user.

21. A system for providing information to a user comprising:
means for executing an application to generate a display field on a mobile appliance;
means for receiving information at the mobile appliance; and
means for displaying an indicium such that the indicium informs the user of a category of content associated with the information received, the indicium lacking at least a portion of the content associated with the information received.

22. The system of claim 21, further comprising:
means for storing a group of indicia; and
means for automatically selecting the indicium from among stored group of indicia, each of the indicia being associated with a category of content.

23. The system of claim 21, wherein the means for displaying an indicium is operative to display the indicium at least partially within the display field of the application.

24. A computer-readable medium having a computer program for providing information to a user via a mobile appliance, said computer program comprising:
logic configured to receive a preformatted text stream provided to a mobile appliance; and
logic configured to display an indicium via the mobile appliance, the indicium being configured to inform the user of a category of content associated with the preformatted text stream received, the indicium lacking at least a portion of the content associated with the preformatted text stream received.

25. The computer-readable medium of claim 24, further comprising logic configured to enable the user to actuate the indicium; and
logic configured to display at least a portion of the content associated with the preformatted text stream received upon actuation.

26. The computer-readable medium of claim 24, further comprising logic configured to select the indicium automatically from among a group of indicia stored by the mobile appliance, each of the indicia being associated with a category of content.

27. The computer-readable medium of claim 24, further comprising logic configured to actuate the indicium selectively in at least one of:
a first mode such that at least a portion of the content of the preformatted text stream received is displayed to the user;
a second mode such that at least a portion of the content of the preformatted text stream received is stored in memory of the mobile appliance and the indicium is removed from the display field; and
a third mode such that at least a portion of the content of the preformatted text stream received is deleted from the mobile appliance and the indicium is removed from the display field.
